(19) United States
(12) Patent Application Publication
(10) Pub. No.: US 2023/0320376 A1
(43) Pub. Date: Oct. 12, 2023

(54) PROCESS FOR SEPARATING COMPONENTS OF SKIM MILK

(71) Applicant: Food Mechanique Australia Pty Limited, Donvale (AU)

(72) Inventor: Stanley Alan Robert KILROY, Donvale (AU)

(21) Appl. No.: 18/020,715

(22) PCT Filed: Aug. 12, 2021
(86) PCT No.: PCT/AU2021/050889

§ 371 Date: Feb. 10, 2023

(30) Foreign Application Priority Data
Aug. 13, 2020 (AU) 2020902868

(51) Int. Cl. A23J 1/20; A23C 9/142; A23C 9/14; B01D 17/02; A23J 3/10; B01D 9/00; A23C 9/15

(52) U.S. Cl. CPC A23J 1/202; A23C 9/1422; A23C 9/14; B01D 17/0217; B01D 2009/0086; B01D 9/00; A23C 9/1508; A23C 2210/202; A23J 3/10

(57) ABSTRACT

This invention relates to a process for separating components of skim milk, in particular to the extraction of milk proteins and lactose from skim milk powder. The method involves combining skim milk powder with water, raising the temperature of the resulting mixture followed by cooling the mixture to produce a viscous casein fraction and a less viscous lactose fraction, and then separating the two fractions with optional purification.

### FIELD OF THE INVENTION

This invention relates generally to a process for separating components of skim milk. In particular, the invention relates to methods of extracting milk proteins from skim milk powder. Methods of extracting lactose are also described.

### BACKGROUND OF THE INVENTION

Mammalian milk is an emulsion comprising a mixture of proteins, fats, carbohydrates, minerals and vitamins. Several components of milk, such as lactose, casein and whey protein, are commercially useful as raw materials in manufacturing industries. Protein components, such as casein and whey protein, find application in the manufacture of food and beverages. Lactose finds application in food and beverage manufacture as well as being an important ingredient in the pharmaceutical and cosmetics industries.

Lactose is a disaccharide composed of the monosaccharides galactose and glucose. Lactose is commonly used as a carrier, stabiliser or excipient in the pharmaceutical and cosmetic industries due to its useful physical properties, mild flavour and low cost. In particular, it finds application as a formulation excipient in the preparation of pharmaceuticals, especially in oral unit dose formulations such as tablets due to its useful compression properties. Lactose also finds application in the food and beverage industries, particularly in biscuit and baked goods manufacture, and as a filler or flavouring in processed foods and snack foods, such as potato crisps, salad dressings and dairy spreads. Lactose is also commonly used in the manufacture of infant formula.

Whey protein is a mixture of globular proteins, mainly α-lactalbumen and β-lactoglobulin. Whey protein is generally used as a dietary supplement, particularly for sports nutrition, muscle building, or for the sick or elderly, and can also find application as an ingredient in processed foods and infant formula.

Casein is a phosphoprotein commonly found in milk from mammals such as cow, buffalo, goat, sheep, yak and camel. The amount of casein present depends on the source of the milk. Casein comprises approximately 80% of the protein in cow's milk, and is a major component of cheese. Casein is not coagulated by heat. Coagulation of casein in milk by the enzyme rennin is the basis for curd formation during cheese production. During the clotting process proteases act on a soluble portion of the casein protein, κ-casein, to promote an unstable state that results in clot formation. Casein is a nutritional source of amino acids, calcium and phosphorus in the diet. Casein is sensitive to acid conditions and, when consumed, it forms a gel or clot in the stomach which provides a sustained slow release of amino acids into the bloodstream, making it useful as a protein supplement in the diet. This finds particular application in nutritional formulations; particularly for infants, the sick, or for sport nutrition. Casein may also be used in the manufacture of infant formula. Casein also finds application in dental products to stabilize amorphous calcium phosphate and release the calcium phosphate onto tooth surfaces to facilitate remineralization.

Casein is generally isolated on a commercial scale from skim milk. Skim milk is commonly produced as a by-product of commercial butter manufacture where the milk fat is removed from whole milk for conversion to butter, leaving the skim milk. The skim milk contains mainly water, milk proteins and lactose. The milk proteins comprise approximately 80% casein, the remainder comprising mainly whey proteins. Typical methods of extracting milk proteins from skim milk on a commercial scale include acid precipitation or rennet precipitation.

Whey protein and lactose are commonly produced on an industrial scale from whey that is generated in large quantities as a by-product of the cheese industry. Whey is the residue remaining after the clotted curd solids, comprising casein and fat, have been separated off to make cheese. The whey proteins can be isolated by concentrating the whey by removal of water, followed by spray drying.

Advances in filtration technology, such as ultrafiltration and membrane separation technology, has facilitated the development of improved processes for isolating milk proteins. Thus, skim milk may be fractionated by ultrafiltration to make a lactose reduced protein concentrate. Subsequent use of membrane separation techniques can be used to remove some of the lactose, minerals and water. The residue containing mainly the milk proteins and some lactose is then evaporated and spray dried to provide a milk protein concentrate powder. Commercially produced milk protein concentrate (MPC) usually contains a milk protein level of about 40% to 90% by weight, typically about 80%, the balance comprising mainly lactose. The protein mainly comprises casein, the remainder of the protein component being predominantly whey proteins.

Milk Protein Isolate (MPI) is a substance obtained by the partial removal of lactose and minerals from skim milk so that the finished dry product contains about 90% protein by weight. MPI is produced on a commercial scale by filtration methods such as microfiltration, ultrafiltration or diafiltration, or dialysis to remove a portion of the lactose. MPI and MPC contain the casein and whey proteins in substantially the same proportion as that of the original milk.

MPC and MPI have the disadvantage that they both comprise lactose in varying amounts. In addition, neither MPC nor MPI are particularly soluble. This limits their general applicability as a nutritional supplement, or as an ingredient in food processing including cheese milk.

There remains a need for improved commercially viable methods for producing milk components such as milk proteins or lactose that address one or more of the drawbacks of known methods for isolating components of milk. Thus there is a need for methods of producing milk components with higher purity or in a form that is easier to handle and combine with other ingredients. Methods that provide full utilization of the milk components and thus reduce waste are also desirable. In particular, there is a need for developing methods that use less energy or less effluent.

### SUMMARY OF THE INVENTION

The present invention is predicated at least in part on the discovery that a process comprising the steps of raising the temperature of a mixture of skim milk powder and water to temperatures in excess of 93° C., followed by cooling, can effect separation of components of the skim milk powder such as lactose and milk proteins. In particular, the inventor has identified that the present methods provide efficient and effective separation and isolation of lactose and milk proteins. The methods of the invention thus find application in extracting commercially useful lactose from skim milk powder. It has also been discovered that milk protein comprising mainly casein can be separated and isolated from the skim milk powder. Thus, in several aspects, the present invention provides methods of separating, isolating and purifying one or more components of skim milk powder, such as lactose and the milk proteins casein and whey protein. Products obtained by these methods are also provided.

The present inventor has discovered that controlled heating effects a change in physical form of a mixture of skim milk powder and water. This has been discovered to facilitate separation of components of the skim milk. Thus, on raising the temperature of the mixture of skim milk powder and water (“skim milk mixture”) to a temperature of greater than 93° C., for example approximately 95° C. or greater, the skim milk mixture has been found not only to increase in viscosity, but it has also been discovered that this heated skim milk mixture, on cooling, can separate into two fractions by virtue of the process of syneresis. Thus, a viscous fraction comprising milk protein, hereinafter referred to as the “casein mass” or “casein fraction”, can be separated from a less viscous fraction comprising lactose, hereinafter referred to as the “lactose fraction”.

The heated skim milk mixture may be subjected to further processing steps to assist in separating the casein fraction and lactose fractions and isolating and purifying components. Such steps include allowing the mixture to cool. Cooling results in the lactose fraction being exuded from the casein fraction as the protein shrinks, thus assisting in separation of the fractions. Shrinkage of the casein fraction is believed to involve contraction of casein micelles causing expulsion of lactose from the micelles. The mechanism of the separation of the two fractions has been found to be particularly efficient and effective with regard to producing milk protein and lactose with good levels of purity.

It will be understood that the casein fraction, also referred to as the casein mass or casein gel, comprises casein as the major component. However, it will be appreciated that the casein fraction may include whey protein in addition to the casein protein. However, casein will generally be present as the major protein component and comprises at least 75% by weight of the protein present in the casein fraction. In addition to milk proteins, the casein fraction may further comprise one or more additional non-protein components such as water and impurities including, but not limited to, one or more of lactose, minerals and riboflavin. These impurities may be substantially removed from the casein fraction by one or more purification steps, such as washing with water.

Similarly, the lactose fraction will generally further comprise water and one or more impurities including, but not limited to whey protein, minerals, casein or riboflavin. The amount of impurities present may be reduced or substantially eliminated by selection of purification processes well known in the art. For example, lactose may be isolated by crystallization of the lactose fraction.

Use of additional processing steps may be employed to effect isolation and purification of the protein (casein fraction) and/or lactose fractions. Thus, washing the casein fraction with water facilitates the removal of soluble impurities, such as residual lactose. Water washing of the casein fraction may also remove a portion of the whey protein. In preferred embodiments, the casein mass comprises mainly casein and minor amounts of whey proteins. In some embodiments, casein comprises at least 80%, at least 85%, at least 90%, at least 95% or at least 98% by weight of the total protein in the casein fraction. In preferred embodiments, the casein fraction includes only low levels of non-protein impurities. It may also be possible to recover whey protein from the water washings if desired.

Thus, judicious selection of a heating/cooling regime in combination with selection of one or more further processing steps provides one or more of isolated milk protein and lactose. In some embodiments there is provided one or more of casein, lactose and whey protein. This maximizes the yield of commercially useful components from the skim milk powder, and reduces waste.

Accordingly, in one aspect the present invention provides a method for extracting at least one component from skim milk powder comprising the steps of:
a) combining the skim milk powder with water;
b) raising the temperature of the resulting mixture to greater than 93° C., preferably greater than 95° C.;
c) cooling the mixture to produce a viscous casein fraction and a less viscous lactose fraction; and
d) separating the lactose fraction from the casein fraction; and, optionally,
e) purifying one or both fractions.

In a further aspect there is provided a method of treating skim milk powder comprising the components lactose and milk proteins to facilitate extraction of at least one of these components, the method comprising combining the skim milk powder with water and raising the temperature of the resulting mixture to greater than 93° C., preferably greater than 95° C., followed by cooling to effect separation of the components.

### DEFINITIONS

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

The articles “a” and “an” are used herein to refer to one or to more than one (i.e. to at least one) of the grammatical object of the article. By way of example, “an element” means one element or more than one element.

By “about” or “approximately” is meant a quantity, level, value, number, frequency, percentage, dimension, size, amount, weight or length that varies by as much as 10, 9, 8, 7, 6, 5, 4, 3, 2 or 1% to a reference quantity, level, value, number, frequency, percentage, dimension, size, amount, weight or length.

When used herein the term “% w/w” and “% w/v” mean, respectively, weight to weight and weight to volume percentages. Similarly “% by weight” means weight to weight percentage.

As used herein, the term “and/or” refers to and encompasses any and all possible combinations of one or more of the associated listed items, as well as the lack of combinations when interpreted in the alternative (or)

As used herein, the term “syneresis” refers to separation of a liquid, or less viscous fraction, from a more solid or viscous fraction. In the methods described herein, syneresis occurs as the result of a process whereby the physical form of milk protein, primarily casein, is changed by heating. This causes the casein to form a viscous protein or “casein” fraction or mass which separates from at least a substantial proportion of a less viscous lactose fraction. Contraction of the structure of the casein mass is believed to involve contraction of casein micelles. This contraction is accompanied by separation of the lactose fraction as it is exuded from the casein micelles.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps. Thus, the use of the term “comprising” and the like indicates that the listed integers are required or mandatory, but that other integers are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

### DETAILED DESCRIPTION OF THE INVENTION

Skim milk is produced by removing cream, also known as milk fat, from whole milk. Skim milk is typically a by-product of butter manufacture. Typically, skim milk will contain up to approximately 0.2% of milk fat. Skim milk powder is manufactured by evaporating skim milk to dryness, usually by a well known method such as multiple effect evaporation, spray drying, freeze drying or drum drying. The milk powder will contain lactose, milk proteins and minerals in the same proportions as the milk from which it was produced, however the moisture (water) content is greatly reduced. Milk powder has greatly improved shelf life compared to fresh milk, and its reduced weight and volume makes it convenient and economic for transportation and storage. Most milk powder is obtained from cow's milk, but milk from other mammals such as buffalo, sheep, camel, horse, yak and goat may also be dried. In preferred embodiments, skim milk powder used in the methods described herein is derived from cow's milk.

The present inventor has discovered that components of skim milk powder may be separated by controlled heating and cooling of skim milk powder in the presence of water to effect separation of the skim milk into a casein (protein) fraction and a lactose fraction. The fractions can then be isolated and purified as required. The inventor has identified that the casein (protein) fraction can be obtained in a form that is of higher purity than milk protein obtained by known commercial methods. For example, commercially produced milk protein concentrate (MPC) typically may contain about 20% lactose by weight. Commercially produced milk protein isolate (MPI) typically may contain about 10% lactose by weight. The presence of lactose in the milk protein may be undesirable for many purposes, particularly if low lactose or substantially lactose-free milk protein is required. In preferred embodiments, the casein fraction obtained by the processes described herein typically contains milk protein in an amount of greater than 90% or greater than 95% based on total solids. In preferred embodiments, the casein fraction comprises less than 10%, less than 8%, less than 6%, less than 5%, less than 4%, less than 3% less than 2% or less than 1% lactose by total weight of solids. In preferred embodiments, the isolated casein fraction is substantially free of lactose.

The casein fraction contains the milk proteins casein and whey protein. Preferably the casein fraction comprises greater than 75%, greater than 80%, greater than 85%, greater than 90% or greater than 95% or 98% by weight of casein based on total weight of milk protein. Typically the protein component of the casein fraction comprises casein in an amount of from about 75% to about 100% by weight, the remainder of the protein component comprising whey proteins. Preferably, the casein fraction comprises casein in an amount of about 80% to about 100% by weight of total milk protein, for example from about 80% to about 98%, from about 85% to about 98%, or from about 90% to about 98% casein by weight of total milk protein.

In some embodiments, the methods described herein can have the effect of reducing the amount of whey protein present in the recovered milk protein when compared to the original composition of milk proteins in the original skim milk. This has the effect of increasing the amount of casein present in the recovered milk protein.

An advantage of using skim milk powder as the starting material for the processes of the present invention is that it greatly reduces the amount of water present during heating and cooling steps. The isolation of the individual components is simpler, more efficient and more convenient. The overall process relies on the use of a minimum amount of water during heating which reduces working volumes and costs associated with heating, handling and disposal. Furthermore, the water consumption for the processing steps is lower than that for known commercial processes for extracting milk proteins as the casein fraction obtained in the methods described require less purification than known methods. In particular, the separation of lactose is simpler and requires less washing to remove lactose residue. This reduces water consumption as well as having the effect of reducing the amount of effluent.

Skim milk powder also contains a high concentration of lactose. The inventor has advantageously discovered that, in addition to providing an efficient method for isolating milk protein, the methods described herein are useful for extracting lactose from the skim milk powder. It has been discovered that the lactose may be isolated in high yield and high purity.

Skim milk powder made from cow's milk typically contains lactose in an amount of 49-52% and protein in an amount of about 31-37% by weight. Skim milk powder useful in the methods herein typically comprises protein (33% ±2), lactose (about 51%), fat (maximum 1.255%), moisture (maximum 4% max), ash (about 8.2%), wherein the percentages are by weight. The protein component typically comprises casein in an amount of approximately 80% w/w, the remaining protein mainly comprising whey proteins such as α-lactalbumen and β-lactoglobulin. With respect to the processes described herein, the whey protein nitrogen index (WPNI) of the skim milk powder is preferably less than 6 mg/g.

Whey protein nitrogen index (WPNI) is a measure of un-denatured whey protein nitrogen (WPN) content expressed as milligrams of WPN per gram of skim milk powder. Skim milk powders are classified as low-, medium- and high-heat powders. Typical WPNI values for low heat, medium heat and high heat powders are ≥6.0, 1.51 to 5.99 and ≤1.5 mg WPN per gram of powder, respectively. Medium-heat and medium high-heat powders are in the WPNI ranges 4.51 to 5.99 and 1.51 to 4.50 mg WPN per gram of powder respectively.

The methods of the present invention are particularly suitable for application to skim milk powder with a WPNI of up to 5.99 mg/g, i.e. high-heat or medium-heat skim milk powders. In some embodiments, high-heat skim milk powder with a WPNI of ≤1.5 mg/g, is preferred. In some embodiments, the use of high-heat skim milk powder can result in recovery of increased yields of milk protein. The ease of processing and formation of the casein fraction may also be improved. It has also been observed that high-heat skim milk powders may result in a reduction in the amount of riboflavin and/or lactalbumin retained in the precipitated casein fraction after washing.

In some preferred embodiments, the methods of the invention facilitate the separation, isolation and purification of casein from skim milk powder. Casein is typically present in an amount of about 27-30% by weight of skim milk powder. Due to its clotting ability, casein finds application as an ingredient in food processing and manufacture. Moreover, casein finds use as an ingredient in sports nutrition products and foods for infants, the sick and the elderly.

The inventor has surprisingly discovered that the milk protein isolated from skim milk powder using the present methods is conveniently obtained in the form of a milk protein structure comprising milk protein and water. For convenience, this agglomerated milk protein structure will hereinafter be referred to as a gel or milk protein gel. Typically this gel comprises milk protein in an amount of from about 30% to about 70% by weight, for example from about 30% by weight to about 60% by weight, or about 40% by weight to about 60% or 70% by weight, the remainder of the fraction substantially comprising water. In some embodiments, the gel is concentrated and is in the form of a gel concentrate comprising greater than 60% or greater than 70% by weight of milk protein. The milk protein comprises mainly casein, the remainder being whey proteins.

Although the recovered milk protein gel may be subjected to a drying step to remove more water, further drying of the concentrate is considered unnecessary. When used in food processing, casein (or milk protein) is generally used in an amount of about 5% to about 10% of the total mass of processed food product. Accordingly, it is believed that when used in these relatively small amounts, milk protein gel obtained by the present invention will add only a very small amount of moisture to the processed food and will have a negligible impact on the overall formulation and properties of the processed food product. However, if required, the milk protein may be dried to remove more water by known processes.

The inventor believes that the properties of milk protein gel extracted using the methods described herein are likely to give it the ability to form emulsions with other food ingredients such as whole milk, oils and fats, thus making it useful in the manufacture of butter emulsions that are spreadable at low temperatures.

This milk protein gel may also have an advantage of being readily dispersible in water. This property provides a form of milk protein, or casein, that is easy to incorporate during the manufacture of food products. Furthermore, the milk protein gel obtained by these methods provides an agreeable “mouth feel” when consumed and is pleasant on the palate. When incorporated into processed food products it dissolves in the mouth in an agreeable fashion. Without being bound by theory or mode of action, it is believed that these advantageous properties are due in part to the milk protein gel having a slightly higher specific gravity than water.

The milk protein gel prepared by the processes of the invention is amenable to being packaged in a similar manner to food products such as cheese. Thus, it may be packaged under vacuum in a barrier film for storage. The vacuum packed protein may subsequently be packaged for transportation and storage, for example in cardboard. The inventor has observed that the packaged gel concentrate has a shelf life of at least one year.

The methods of the invention may also facilitate the isolation of whey protein from skim milk powder. For example, whey protein may be obtained by washing the casein fraction. Whey protein is a mixture of globular proteins, mainly α-lactalbumen and β-lactoglobulin, which comprises approximately 20% by weight of the protein in cow's milk. Whey protein is mainly obtained as a by-product of cheese production, and may be provided in the form of a concentrate, isolate or hydrolysate. Whey protein extracted from skim milk is known as native whey protein. Whey protein is present in an amount of about 6-8% by weight in skim milk powder. Whey protein is generally used as a dietary supplement, particularly for sports nutrition, and is also used as an ingredient in processed foods and infant formula. Whey proteins may be isolated or extracted from the protein (casein) fraction and/or the lactose fraction. In some embodiments, the whey protein may be obtained by washing the protein (casein) fraction and/or the lactose fraction with water and isolating the whey proteins from the washings.

In some embodiments, methods of the invention facilitate the separation and isolation of lactose from skim milk powder. Lactose is a disaccharide composed of the monosaccharides galactose and glucose and comprises approximately 2-5% by weight of milk. Typically skim milk powder contains about 49-52% lactose. Lactose is commonly used as a carrier, bulking agent or excipient in the pharmaceutical and cosmetic industries. In particular, it finds application as a formulation excipient in the preparation of pharmaceuticals, especially in oral unit dose formulations such as tablets, due to its useful compression properties. Lactose is commonly used in the manufacture of infant formula to assist in achieving a lactose level comparable with the composition of human milk. Lactose also finds application as an ingredient in processed food manufacture and, as it is not fermented by yeast, it may be used to sweeten beer.

Known commercial processes for extracting lactose from milk are time consuming and may take several days. One particular drawback of known processes is that lactose has a tendency to solidify in the lines of the processing equipment causing blockages.

When produced by the processes described herein, lactose is obtained as an aqueous concentrate comprising crystals. Typically the concentrate comprises crystalline lactose at about 40% to about 45% solids, or up to about 48% solids. The lactose has been observed to commence crystallization almost immediately after separation and isolation from the casein fraction. Lactose in this form is easy and convenient to handle and is less likely to cause pipe blockage due to rapid crystallization to form a solid mass in processing equipment. A lactose concentrate comprising from about 40% to about 45% solids may be dried by spray drying without the need for any other drying step.

In some embodiments, the yield of lactose isolated using the methods of the invention is about 60-75%, or approximately 70%, based on the estimated amount of lactose present in the skim milk powder.

Preferably the process of raising the temperature of the skim milk powder in the presence of water involves mixing the skim milk powder with water, preferably purified or food grade water, prior to commencement of heating the mixture using a heat source. Preferably the skim milk powder is thoroughly mixed with water to provide reconstituted skim milk prior to commencement of raising the temperature. Preferable the reconstituted milk is in a concentrated form, such as concentrated reconstituted milk. Methods of effecting mixing, stirring or agitation are well known in the art and the skilled person will be able to select an appropriate method according to the circumstances. In some examples, the skim milk and water are combined by blending or homogenizing. It will be appreciated that mixing may be continued during some, or all, of the heating process. Preferably mixing is continued throughout the process of raising the temperature.

The ratio of water to skim milk powder in the processes described herein is preferably about 60:40 to 40:60 by weight, for example 55:45 to 45:55; or about 50:50 by weight. In some embodiments, the ratio of water to skim milk is approximately 3:2 to 2:3; 11:9 to 9:11; 10:9 to 9:10; and preferably approximately 1:1 by weight.

In the methods of the present invention, preferably the skim milk powder and water are at ambient temperature prior to commencing controlled raising of the temperature. Preferably the skim milk powder and water mixture has an initial temperature of less than 30° C.; more preferably less than 25° C.

The temperature of the skim milk powder and water mixture is raised to greater than 93° C. and preferably greater than 95° C. In some embodiments, the temperature is raised to from about 93° C. to about 110° C. or more, or from about 95° C. to 100° C., or from 93° C. to 98° C. Preferably, the mixture is heated to a maximum temperature of from about 95° C. to about 110° C., from about 95° C. to about 100° C., or about 95° C. to about 100° C. The mixture may be heated under conditions where the rate of raising the temperature is controlled. In some embodiments, the rate of raising the temperature of the mixture is controlled in such a way that any temperature differentials within the mixture are minimized. Preferably the temperature of the mixture is raised over a period of from about 10 minutes to about 30 minutes, for example about 10 minutes to about 25 minutes.

Controlled heating of the skim milk powder and water mixture allows heating of the mixture to the desired final temperature in a manner that may facilitate separation of the milk protein and lactose whilst mitigating against the risk of the casein undergoing irreversible shrinkage due to expulsion of water during the heating process. Without being bound by theory, it is believed that the raising of the temperature of the mixture results in expansion of the casein micelles present in the skim milk. The resulting expanded micelles are believed to absorb water which serves to stabilize the casein protein structure during heating. This is believed to avoid or reduce expulsion of water from the casein structure and thus avoiding irreversible shrinking of the casein fraction, thus allowing the temperature of the skim milk to be raised to a temperature in excess of 93° C. to facilitate separation the lactose and casein fractions.

During heating, the skim milk mixture undergoes a slight, but visually observable, increase in viscosity. This is believed to be due to the formation of a viscous casein fraction. When heating is stopped, commencement of separation of the fractions is observed, usually almost immediately. Further cooling of the mixture results in separation of the fractions into two phases by syneresis. Cooling to a temperature of, for example, from about 70° C. to 85° C. facilitates separation of the viscous casein comprising protein fraction or mass from a less viscous fraction comprising mainly lactose and other milk components such as whey protein and minerals. The mixture can be cooled, or left to cool, to temperatures below this temperature range without adverse effect since the fractions will have separated. What is important is that the mixture has cooled to a temperature at which the fractions separate. Without wishing to be bound by theory, it is believed that heating skim milk powder in the presence of water to a temperature of greater than 93° C. or greater than 95° C. causes the casein in the skim milk to form a particular quaternary protein structure. At this elevated temperature, the casein adopts the form of a viscous fraction or mass which facilitates separation from the less viscous lactose fraction. Shrinkage of the casein fraction on cooling results in expulsion of the lactose fraction from within the casein mass by the process of syneresis, thus aiding separation of the fractions.

The skilled person will appreciate that the precise chemical compositions of milk will vary considerably according to various factors such as breed, as well as the individual animal. Factors such as the animal's diet, health and age, as well as the time of year, weather and geographical area may all impact the composition of the milk. Thus, skim milk powder will vary and this may affect its reaction to heating. It will be understood that there may be some variation in the behaviour of batches during the heating and cooling steps of the processes described herein. In certain circumstances, during separation of the fractions during cooling, the fractions may recombine. Without wishing to be bound by theory, it is believed that this may occur due to the casein micelles failing to have expelled sufficient moisture, or having recombined with the rejected moisture. This may occur, for example, if the temperature at separation is too high or there is too much water, or if an excess of the less viscous fraction present. The skilled person will understand that in some circumstances it may be necessary or advantageous to cool the mixture to a lower temperature, for example 60° C. to 70° C. or 65° C. to 75° C. prior to separating and processing the mixture.

Preferably, the heated product mixture is allowed to cool to such a temperature as to permit separation of the fractions, particularly by centrifugation, without re-combination of the two fractions. This temperature is considered to be a temperature wherein the casein micelles have rejected sufficient moisture and will not re-adsorb moisture without application of further heat.

In a preferred embodiment, there is provided a method for extracting at least one component of skim milk powder comprising the steps of:
a) combining the skim milk powder with water, preferably with mixing, preferably the ratio of water to skim milk powder is in the range of 3:2 to 2:3,
b) raising the temperature of the resulting mixture to greater than 95° C.;
c) reducing the temperature, for example to about 80° C. to 85° C., to effect separation of a less viscous lactose containing fraction from a viscous protein fraction by syneresis; and, optionally
d) isolating the less viscous fraction from the viscous protein fraction; and, optionally
e) purifying one or both fractions.

In preferred embodiments, the protein fraction is a casein fraction as hereinbefore defined.

Suitable methods of controlling the temperature are described in PCT/AU2008/000512, published as WO 2008/122094 (Kilroy, 16 Oct. 2008), the contents of which is incorporated herein by reference.

Preferably the raising of the temperature is controlled in such a way that the temperature differential within the mixture is minimized. In some embodiments, the temperature differential is minimized for at least a portion of the heating process. In some embodiments it may be useful to minimize the temperature differential when the mixture temperature is raised between from about 45° C. to about 65° C., for example from about 50° C. to about 60° C. In some embodiments, preferably the temperature differential is minimized throughout the heating process. Preferably the temperature differential within the skim milk powder and water mixture is no more than 5° C. More preferably, the temperature differential is no more than 3° C. or 2° C. Methods for measuring temperatures and determining temperature differentials will be well known to a skilled person.

Various methods are known and used by the skilled person in the field of food processing and technology for heating food products. Methods of reducing temperature differential, for example by employing means to ensure that there is efficient heat transfer within the skim milk mass. One technique is the use of a slow increase in temperature that permits efficient conduction of heat away from the heating surface to the cooler parts of the skim milk mass at a similar rate to the rate of heating of those portions of the skim milk mass that are closest to the heating surface. Preferably the temperature of the skim milk mass is heated at a rate of less than 5° C. per minute, more preferably at a rate of less than 2° C. per minute and most preferably at a rate of less than 1.5° C. per minute. It will be appreciated that the rate of temperature increase may vary throughout the duration of the method. Another technique for minimizing the temperature differential is the use of a slow increase in temperature combined with pausing of the heating process at regular intervals to allow conduction of heat away from the heating surface to cooler parts of the skim milk mass at a rate similar to the rate of heating of those portions of the skim milk mass that are closest to the heating surface. In some embodiments, the methods use a heating method wherein the temperature of the heat source is increased slowly. This may be combined with optional periods wherein the increase in temperature is reduced or paused. In these embodiments, the heating method incorporates periods wherein the increase in temperature of the heating surface is halted, the temperature of the heat source is preferably increased at a rate of less than 5° C. per minute for a period of less than 5 minutes, followed by a pause in temperature increase for a period of less than 5 minutes. More preferably, the temperature of the heat source is increased at a rate of between 2 and 3° C., and preferably 2° C., per minute for 2.5 minutes, followed by pausing of the temperature increase for a period of 1 minute.

Another technique for minimizing the temperature differential throughout the skim milk powder mixture is the sealing of the reaction vessel to reduce heat loss through radiation, conduction or convection. The sealing process may effect either complete sealing, wherein the pressure within the vessel changes with variation in temperature; or partial sealing, wherein the pressure within the vessel does not substantially change with variation in temperature. Regardless of the degree of sealing of the vessel, it will be appreciated that the skim milk mass may be subjected to variation in pressure. The regulation of pressure may serve to control moisture loss from the skim milk mass. In some preferred embodiments, the temperature of the mixture is raised under increased pressure. The skim milk powder mixture may also be subjected to reduced pressure through use of a mechanical device or water aspirator.

In some embodiments, the maximum temperature to which the skim milk powder and water mixture is heated at atmospheric pressure is about 93° C. to about 105° C., preferably about 94° C. to about 100° C. More preferably the maximum temperature to which the skim milk mixture is heated is about 95° C. to about 100° C., preferably about 95° C. to 98° C.

After the temperature of the skim milk powder and water mixture has been raised to the desired temperature by heating, the resulting mixture of fractions may be subjected to additional processing steps. For example, in some preferred embodiments the mixture may undergo cooling. Methods of cooling a reaction vessel are well known in the art. Preferably the mixture is cooled to a temperature of from about 65° C. to about 90° C., for example from about 70° C. to about 85° C., or about 75° C. to about 85° C. In a preferred embodiment, the mixture is allowed to cool to a temperature of about 80° C. to about 85° C. Cooling may be effected by, for example, removing or inactivating the source of heat, or by applying active cooling. The cooling process may be carried out with or without mixing. In some embodiments, preferably the mixture is not stirred or otherwise mixed or agitated during cooling. Cooling promotes separation of the two fractions as the less viscous lactose fraction is exuded, or expelled, from within the casein fraction as the structure of the casein shrinks. While cooling to lower temperatures is possible, it is not necessary to carry out the process.

The casein fraction may be isolated from the lactose fraction by any suitable means for separation of phases or fractions known in the art such as, for example, decanting, syphoning, centrifugation or filtering; or using a combination of techniques. Preferably the fractions are separated by centrifugation in accordance with known methods. In some embodiments, use of a rotary centrifuge is preferred for separating the two fractions. In some embodiments, decanting methods are preferred, for example horizontal decanting methods may be used. In some embodiments, it may be advantageous to use a combination of techniques to improve yield and purity of the isolated components from the fractions. For example, centrifugation, such as rotary centrifugation, may be used to assist in separation of the fractions. This may be followed by isolation of the two fractions by decantation, filtration or syphoning, for example horizontal decantation. The casein solids may be isolated using a fine mesh screen in the rotary centrifuge. In some embodiments, the lactose and casein fractions may be separated by filtration, for example using a stainless steel or polyester 100 micron mesh. Typically, after an initial centrifugation, the lactose fraction is substantially expelled from the casein fraction and the two fractions can be separated. In some preferred embodiments, the viscous casein fraction and the less viscous lactose fraction are separated and isolated using a combination of rotary centrifugation and separation by horizontal decantation.

It will be appreciated that it may be desirable for the isolated fractions to separately undergo one or more additional processing steps to assist in isolation and/or purification of the desired component. It will also be understood that the level of purification required will depend on the intended application of the isolated component.

The casein fraction comprises casein as the major solids (non-water) component in addition to whey proteins and other minor components such as lactose, riboflavin and minerals. The casein may be purified to the level of purity desired according to known procedures. Preferably the casein fraction may be treated by washing with water to remove at least a portion of any water soluble impurities, such as lactose. Washing with water may also serve to separate at least a portion of whey solids from the casein. Preferably the casein fraction is washed at ambient temperature. In some circumstances it may be desirable to repeat a washing process. Accordingly, washing of the casein mass may be repeated with fresh water on one, two, three, or more occasions to remove impurities. In some preferred embodiments it is desirable to agitate by, for example, shaking, mixing, stirring or otherwise circulating the mixture, during the washing procedure. Agitation during washing facilitates the dissolution of any remaining lactose into the water to allow it to be readily separated from the casein, for example by centrifugation. Agitation may encourage foaming of a portion of whey protein solids present. This may assist in removal of some of whey solids from the casein. The casein mass may be captured by a fine mesh screen of a rotary centrifuge and typically may provide a casein gel product with a solids content of up to 60% or up to 70% or 75% by weight. The isolated casein mass typically contains whey protein as a minor protein component. In preferred embodiments, the casein gel is substantially free of non-protein impurities.

The inventor has observed that purification of the individual fractions by washing is straightforward and effective. In some embodiments, only one or two water washes may be necessary. This provides an advantage of lower water consumption, lower energy consumption and reduced effluent when compared to known methods of isolating casein or lactose from milk. In particular, use of a horizontal decanter separator in combination with counter-current flow can reduce the water consumption during the purification process. In some embodiments, the amount of water required to purify, or “wash” the casein fraction is estimated to be about 50% of that required for purification using a conventional acid precipitation method for producing milk protein. Thus, in preferred embodiments, the amount of water required is estimated to be in the region of about 7.5 to 8 litres of water per kilogram of milk protein (dry weight).

The milk protein thus produced finds particular application in food manufacture, and particularly in the preparation of sports nutrition products and foods for infants and the elderly and sick. The protein may be used as isolated in the processes and methods described herein. However, preferably the milk protein is formulated with other food ingredients, and excipients such as flavourings, colourings, emulsifiers, stabilizers or sweetening agents.

The inventor has identified that casein gel prepared according to the methods described herein is useful for forming emulsions with other food products. Accordingly, the casein gel may advantageously find application in food processing and manufacturing.

The milk protein obtained by this process is also capable of forming an emulsion with an oil or fat which can be used as a basis for spreads, such as butter-like spreads, or sliceable products. This finds particular application in, for example, the preparation of a low fat butter emulsion which retains a spreadable consistency at temperatures as low as 5° C. Processes for producing food products from edible fats and casein are described in WO 83/01728 (Kilroy) which is herein incorporated by reference in its entirety.

During the casein fraction washing step(s), the whey protein solids (mainly α-lactalbumen and β-lactoglobulin) may form a foam, particularly with agitation. This foam may be separated from the casein by any suitable method known in the art, for example by ultra-filtration, and the isolated whey protein solids may be spray dried.

The less viscous lactose containing fraction is exuded from the heated skim milk powder and water mixture as a liquid concentrate which may be coloured yellow or yellow/orange due to the presence of riboflavin derived from the skim milk powder. Typically the lactose fraction will commence crystallization following separation and isolation from the protein fraction. Crystallization may be assisted by reducing the temperature of the lactose fraction after isolation, for example to about 5° C. Typically the crystallization of lactose is complete in about five to eight hours. Residual whey proteins remaining may be separated from the lactose by centrifugation and/or washing.

It will be appreciated that lactose is known to exist in the form of alpha- and beta-anomers. In aqueous solution, the two anomeric forms exist as an equilibrium mixture. In methods described herein, the lactose crystals forming in the lactose fraction immediately following separation from the casein mass are crystals of α-lactose. These crystals are typically of sufficient diversity of size and dimension to be used as seeds to initiate crystallization of lactose isolated in successive processing steps. The lactose crystals may form in an anhydrous or an hydrated form.

The methods described herein are applicable to any scale, such as small scale, pilot scale or commercial scale. Suitable apparatus or equipment for batch or continuous processes are well known in the art. The method may be performed as a continuous process however, in some embodiments, preferably the method is performed as a batch process. An example of apparatus for effecting heating during a batch process includes a vessel, preferably having a glass or stainless steel interior surface. One such vessel is known as a cheese kettle. Typically such a vessel will include a heating jacket capable of controlling the temperature of the vessel contents by circulating a fluid in the jacket to effect heating or cooling of the vessel contents. Other examples of heating equipment include tubular heat exchangers and swept surface heat exchangers. The skilled person will be aware of processes and equipment suitable for combining and mixing the skim milk powder and water. In some preferred embodiments, the apparatus effects mixing using an impeller. The vessel may also allow for the contents to be removed at any stage.

After the skim milk and water mixture has been heated to effect formation of the two fractions, the contents of the vessel may be removed prior to effecting separation of the fractions. In some methods, the contents are transferred to a rotary centrifuge for separation. Preferably the rotary centrifuge includes a fine mesh screen to capture the casein fraction.

The methods may be performed as a continuous process on a commercial scale. For example, the vessel may be in the form of a pipe through which the flow of the skim milk powder and water mixture may be regulated by, for example, pumping. The methods of the invention may take place according to the movement of the mass through a heating and a cooling zone. The pipe may be adapted to facilitate separation of the fractions, for example by bifurcation of the pipe and/or use of a mesh for filtration. The two fractions may then be purified separately.

In order that the invention may be readily understood and put into practical effect, particular preferred embodiments will now be described by way of the following non-limiting examples.

### EXAMPLES

Skim milk powder used in the methods described herein was commercially available medium- or high-heat skim milk powder with a WPN Index of ≤1.5 mg/g.

### Example 1

### Separation of Components of Skim Milk Powder

Skim milk powder (500 g, cow milk, 32.6% protein, 51.5% lactose) was combined with water (500 g, food grade) in a processor to give concentrated reconstituted skim milk. The mixture was heated in a vessel fitted with a heating jacket filled with liquid heating medium. The mixture was heated at a rate of 1.5° C. per minute, while the temperature differential between the product and heating medium was maintained at less than 3-5° C. throughout. Heating was maintained until the temperature of the mixture reached approximately 95° C., by which time the viscosity of the mixture was observed to have raised slightly. Stirring (agitation) was stopped and the mixture was then allowed to cool to approximately 80° C. to allow the less viscous fraction to be expelled from the more viscous shrinking protein mass to effect separation. During this time, the mixture was transferred to a rotary centrifuge where the less viscous lactose fraction (B) was removed leaving the viscous casein mass (A).

The casein mass (A) was purified by circulating it in a vessel with water to encourage dissolution of residual lactose and foaming of residual whey protein. Lactose impurities were removed in solution by centrifugation. Whey solids were removed as a foam using ultrafiltration. The casein (30% solids, remainder water) was recovered using a 100 mesh polypropylene screen with perforated stainless steel backing. Upon assay, the casein was found to have a purity of 98.3%

The lactose fraction (B) obtained was coloured yellow due to the presence of riboflavin from the skim milk powder. The lactose commenced crystallisation immediately on separation from the casein mass, and crystallisation of the lactose continued when the fraction was maintained at approximately 5° C. for 6 to 8 hours. The lactose crystals may be separated by centrifugation and/or filtration. The lactose crystals isolated comprised α-lactose.

### Example 2

### Separation of Components of Skim Milk Powder

Skim milk powder (500 g, 32.6% protein, 51.5% lactose, WPN index 1.19 mg/g) was combined with food grade water (500 g) in a processor (Stephan Processor, 5 L capacity) to form skim milk concentrate. The processor was equipped with a rotating shaft fitted with knives, a surface scraper and a water vapour jacket. The concentrate was heated by water vapour at 100° C., rising to 110° C.

The mixture was heated to 95° C. to produce a gel which was then removed from the processor into a separate vessel to promote cooling. Syneresis of the gel to produce a casein fraction, and a lactose concentrate became evident on cooling. The mixture was transferred to a rotary centrifuge to separate the saturated lactose concentrate from the viscous casein fraction. Crystallisation commenced on cooling of the lactose concentrate. Standing for approximately 24 hours at 5° C., yielded crystalline α-lactose together with some whey proteins as a minor contaminant. The lactose may be purified by known methods such as filtration, ultrafiltration, centrifugation or washing, or a combination.

The retained casein fraction was then subjected to purification by three phases of washing and centrifugation to reduce the lactose present in the wash.

### Example 3

### Isolation of Milk Protein from Skim Milk Powder

Skim milk powder (500 g, 32.6% protein, 51.5% lactose, WPN index 1.19 mg/g) was combined with food grade water (500 g) in a batch processor to form skim milk concentrate. The concentrate was heated by water vapour at atmospheric pressure.

The mixture was heated to 95° C., the source of heat was removed and the mixture was allowed to cool until syneresis occurred (about 80° C.). The mixture was separated by transferring to a rotary centrifuge to separate the saturated lactose concentrate from the viscous casein (protein) fraction. The rotary centrifuge employed 100 mesh polyester inserts and the speed of rotation was 2800 rpm. Alternatively, a horizontal decanter separator may be used. The filtrate comprised mainly lactose at approximately 35% solids. The yield of lactose recovered was calculated to be approximately 70% based on the estimated amount of lactose in the skim milk powder.

The retained milk protein fraction comprised mainly casein. The protein fraction was then subjected to purification by three phases of washing and centrifugation using fresh water at each stage to remove residual lactose. The amount of lactose present was reduced to about 1.7%. A fourth wash, preferably combined with a counter-current flow, may be used to remove most, or substantially all, of any remaining lactose. Use of a counter-current flow method is more efficient and may reduce the volume of wash water required.

Assuming use of a fourth washing stage in a counter-current flow, it has been discovered that the amount of water required to purify the milk protein produced using the methods described herein is estimated to be about 50% of that required to purify milk protein using known commercial methods. Using a counter-current flow technique for washing the milk protein isolated using the methods described herein is estimated to consume about 7.5 to 8 litres per kilogram of milk protein (dry weight) based upon a laboratory scale assessment.

The methods thus provide an efficient and effective route for separating lactose and milk protein from skim milk. The methods produce lactose in good yield in a concentrated form in addition to producing milk protein containing only low levels of lactose.

The disclosure of every patent, patent application, and publication cited herein is hereby incorporated herein by reference in its entirety.

The citation of any reference herein should not be construed as an admission that such reference is available as “Prior Art” to the instant application.

Throughout the specification the aim has been to describe the preferred embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method for extracting at least one component from skim milk powder comprising the steps of:
a) combining the skim milk powder with water;
b) raising the temperature of the resulting mixture to greater than 93° C.;
c) cooling the mixture to produce a viscous casein fraction and a less viscous lactose fraction; and
d) separating the lactose fraction from the casein fraction; and, optionally,
e) purifying one or both fractions.

2. The method according to claim 1, wherein the ratio of water to skim milk powder is approximately 1:1 by weight.

3. The method according to claim 1, wherein the skim milk powder has a whey protein nitrogen index of less than 6 mg/g, preferably less than or equal to 1.5 mg/g.

4. The method according to claim 1, wherein the rate of raising the temperature is controlled.

5. The method according to claim 1, wherein the temperature is raised over a period of about 10 minutes to about 30 minutes.

6. The method according to claim 1, wherein the mixture is mixed by stirring or agitation.

7. The method according to claim 1, wherein after heating the temperature of the mixture is reduced to between 70° C. and 85° C. to facilitate separation of the viscous and less-viscous fractions.

8. The method according to claim 7, wherein centrifugation, preferably rotary centrifugation, is used to effect separation of the fractions.

9. The method according to claim 7, further comprising the use of decanting or filtration, or both, to separate the fractions.

10. The method according to claim 1, wherein the component is milk protein or casein.

11. The method according to claim 1, wherein the separated casein fraction is purified by washing with water to provide a milk protein gel.

12. The method according to claim 1, wherein the component is lactose.

13. The method according to claim 12, wherein the separated lactose fraction is purified by crystallization.

14. The method according to claim 13, wherein the crystallization step is carried out at approximately 5° C.

15. The method according to claim 12, wherein the lactose is obtained in the form of α-lactose.

16. A method of treating skim milk powder comprising the components lactose and milk protein, preferably casein, to facilitate extraction of at least one component, the method comprising combining the skim milk powder with water and raising the temperature of the resulting mixture to greater than 93° C., preferably greater than 95° C., followed by cooling to effect separation of the components.
